(19) United States
(12) Patent Application Publication
(10) Pub. No.: US 2013/0091711 A1
(43) Pub. Date: Apr. 18, 2013

(54) APPARATUS FOR MAINTAINING A HAIR TREATMENT DEVICE

(71) Applicants: Brenda P.K. Yue, Kowloon (HK); Vito James Carlucci, Stratford, CT (US); Cristian M. Castro Rey, Buenos Aires (AR)

(72) Inventors: Brenda P.K. Yue, Kowloon (HK); Vito James Carlucci, Stratford, CT (US); Cristian M. Castro Rey, Buenos Aires (AR)

(21) Appl. No.: 13/273,329

(22) Filed: Oct. 14, 2011

(51) Int. Cl. B26B 19/38; B26B 19/40

(52) U.S. Cl. 30/124; 15/104.93

(57) ABSTRACT

An apparatus for maintaining a hair treatment device includes a housing, a brush assembly mounted to the housing and having a plurality of bristles dimensioned and adapted for at least one of cleaning and removal of hair from a clipper assembly of a hair treatment device and a dispensing member mounted to the housing and having a treatment agent for depositing on the clipper assembly. The dispensing member may include an absorbent member such as a sponge, pad or cloth. The treatment agent may be one of a lubricant, cleaning agent or medicinal.

### BACKGROUND

1. Technical Field

The present invention relates to a hair clipper or trimmer, and, more particularly, relates to an apparatus for cleaning and maintaining a hair clipper or trimmer. The present invention is further directed to a system or kit incorporating the cleaning apparatus with a hair clipper or trimmer.

2. Description of the Related Art

Electric hair clippers having a clipper blade assembly are known in the art. Most conventional hair clippers include a stationary blade and a reciprocating blade. The stationary blade and the reciprocating blade each have a plurality of teeth along leading edges of the blades. The clipper blade assembly may be mounted to the clipper handle such that the teeth of the stationary blade are substantially parallel to the teeth of the reciprocating blade. In this manner, oscillating the reciprocating blade with respect to the stationary blade trims hair positioned between the teeth. Examples of hair clippers are disclosed in commonly assigned U.S. Pat. Nos. 6,536,116 to Fung and 6,742,262 to Rizzuto et al., the entire contents of each disclosure being hereby incorporated by reference herein.

### SUMMARY

The present invention is directed further improvements in hair clipper or trimmer devices. In accordance with one embodiment, an apparatus for maintaining a hair treatment device includes a housing, a brush assembly mounted to the housing and having a plurality of bristles dimensioned and adapted for at least one of cleaning and removal of hair from a clipper assembly of a hair treatment device, and a dispensing member mounted to the housing and having a treatment agent for depositing on the clipper assembly. The dispensing member may include an absorbent member such as a sponge, pad or cloth. The treatment agent may be one of a lubricant, cleaning agent or medicinal.

A cover may be releasably mounted to the housing to substantially enclose the dispensing member. An annular seal may be mounted to the housing to establish a substantial sealing relation with the cover upon mounting thereof to the housing.

The present invention may further include a hair clipper with the apparatus thereby forming a kit for treating hair.

### BRIEF DESCRIPTION OF THE DRAWINGS

Various embodiments of the present disclosure are described hereinbelow with references to the drawings, wherein:

FIG. 1 is a perspective view of a prior art hair treatment device in the form of a hair clipper or trimmer;

FIG. 2 is a front plan view of the apparatus for maintaining the hair treatment device in accordance with the principles of the present disclosure, illustrating the housing and the cover released from the housing;

FIGS. 3 and 4 are front and side plan views, respectively, of the apparatus of FIG. 2 illustrating the cover mounted to the housing; and

FIG. 5 is a top plan view of the housing with the cover removed illustrating the brush assembly.

### DETAILED DESCRIPTION OF THE EMBODIMENTS

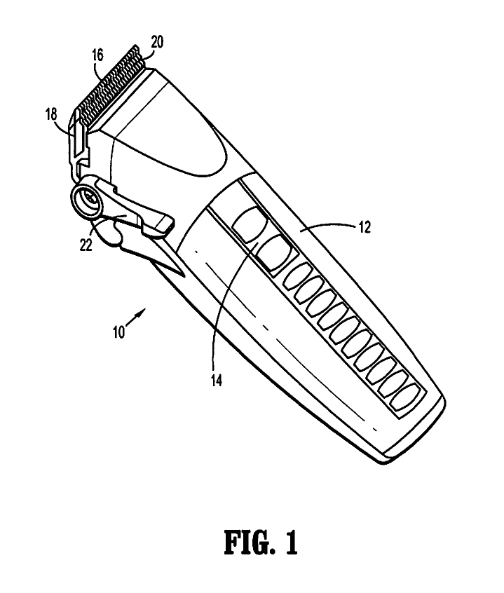

Referring to the drawings and, in particular, FIG. 1, there is shown a prior art hair clipper in accordance with a preferred embodiment of the present invention generally represented by reference numeral 10. Clipper 10 has housing 12, and a motor and driver (not shown) located in the housing 12. The motor and driver can be any conventional driver mechanisms for use in a hair clipper. Housing 12 has user operating switch 14 for turning the motor “on” and “off”. A blade assembly 16 is mounted to the forward end of housing 12. Blade assembly 16 has stationary comb blade 18 and cutter or cutting blade 20. Cutting blade 20 is adapted to reciprocate relative to stationary comb blade 18 to cut hair received between the blades 18, 20. A control lever 22 is provided to adjust the distance between comb blade 18 and cutter blade 20 and, thus, adjust the length or depth of cut. Further details of hair clipper 10 may be ascertained by reference to the Rizzuto '262 patent.

Electric hair clippers of the type described in connection with FIG. 1 require maintenance for proper operation including, e.g., including lubrication of the blade assemblies and removal of foreign substances, e.g., hair clipping, from the blades.

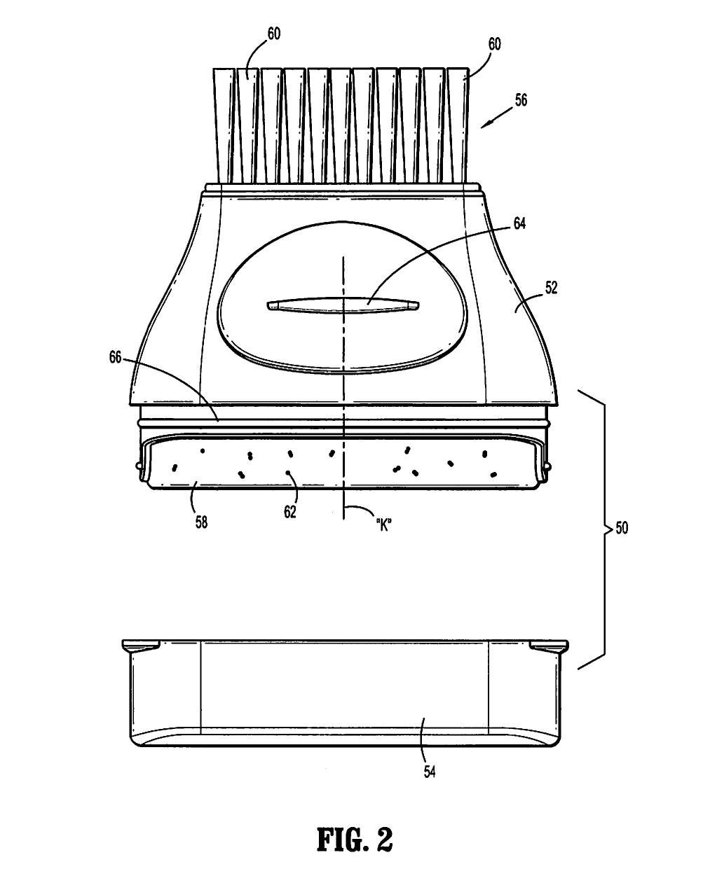

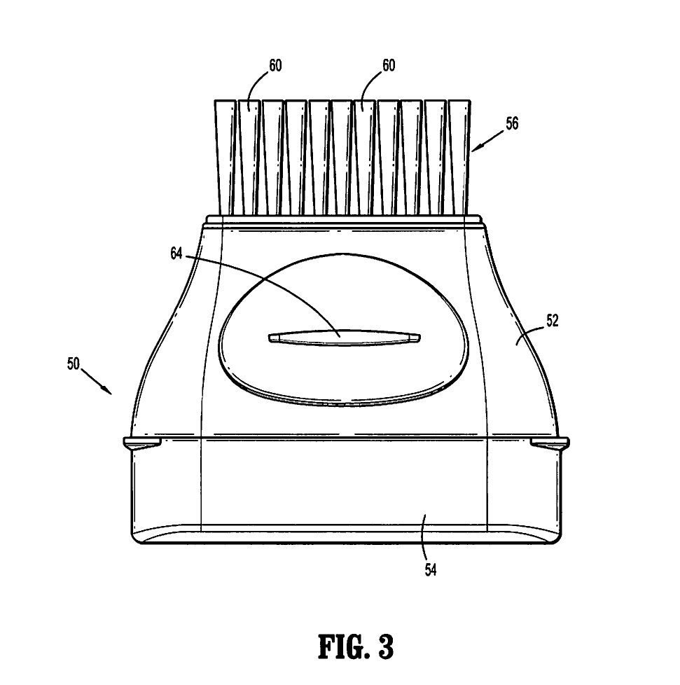

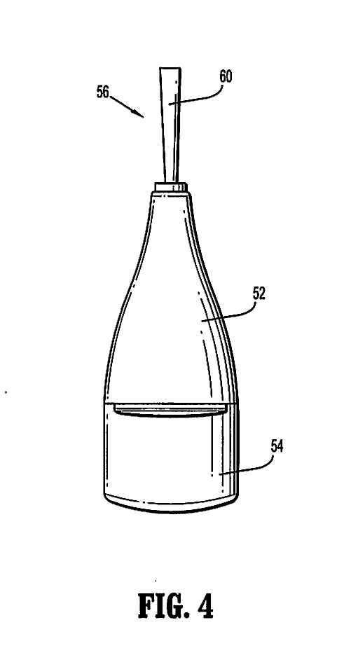

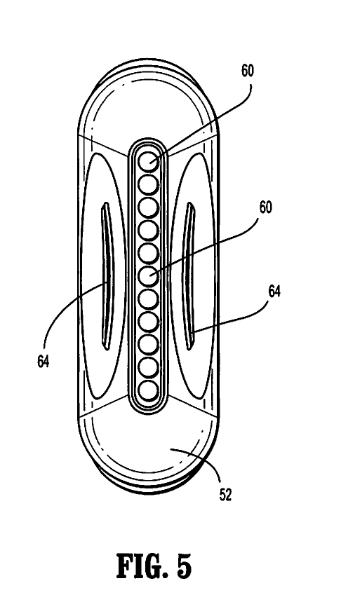

Referring now to FIGS. 2-5, there is illustrated the apparatus for maintaining a hair treatment device in accordance with the principles of the present invention. Apparatus 50 includes housing 52 and cover 54 which is releasably mounted to the housing 52. Housing 52 defines longitudinal axis “k”, and has brush assembly 56 at one longitudinal end and dispensing member 58 at the other longitudinal end. Brush assembly 56 includes a plurality of bristles 60 arranged in a row or linear manner. Bristles 60 may be single elements or may contain multiple strands or fibers. Adjacent bristles 60 may be spaced or may be in contacting relation. Bristles 60 may be fabricated from any suitable natural or synthetic materials including, but, not limited to, horse hair, sable, nylon, polyester or the like. Bristles 60 may be secured to housing 52 through conventional means including but not limited to adhesives or cements, or, may in the alternative, be secured through mechanical means such as, e.g., being mounted within corresponding apertures defined within housing 52.

Dispensing member 58 may include an absorbent member such as a sponge, gel, pad or cloth. Dispensing member 58 may be secured to housing 12 through conventional means including with the use of adhesives or via mechanical means such as screws, fasteners, or possibly may be clamped between opposed segments of the housing 52. Contained, absorbed within, or applied to the surface of dispensing member 58 is treatment agent 62. Treatment agent 62 may include any agent suitable to treat and/or lubricate blade assembly of a hair trimmer or clipper device. For example, treatment agent 62 may be the Forfex Oil FX Clipper/Trimmer oil made available by Conair Corporation of Stamford, Conn. Other lubricating oils for incorporation within dispensing member 58 are also envisioned including silicone, mineral oil, etc. Treatment agent 62 may also include a cleaning oil or soap for cleaning the blade assembly, or may include a medicinal for application to the skin of the user. Suitable medicinals includes antiseptics, anti-fungals, skin creams, oils or the like.

Housing 52 may be advantageously contoured to facilitate grasping by the user and may further include surface irregularities such as one or more gripping ribs 64 on each side to enhance gripping engagement therewith. Housing 52 further includes o-ring seal 66 extending transverse to the longitudinal axis and at least partially encircling the housing 52. Seal 66 facilitates releasable mounting of cover 54 to housing 52 and/or provides a substantial seal within the cover 54 when mounted to the housing 52 to preserve treatment agent 62 contained within dispensing member 58.

With continued reference to FIGS. 2-5, cover 54 is dimensioned for positioning over dispensing member 58 to enclose the dispensing member 58. Cover 54 preferably is dimensioned to compress seal 66 to establish a substantially fluid tight cavity within the interior of the cover 54 to assist in preserving treatment agent 62. Cover 54 may be secured to housing 52 through a friction fit with or without the aid of seal 66, or may be secured through a snap fit coupling relation between the components. Other arrangements are also envisioned including bayonet coupling, screw locks or the like. Cover 54 is dimensioned for repeated application and removal from housing 54.

Subsequent to use of hair clipper or trimmer 10, brush assembly 56 is utilized to remove debris, hair or other objects from the blade assembly 16 of the trimmer 10. Dispensing member 58 is then applied to blade assembly 16 whereby treatment agent 62 is dispensed onto blades 18, 20 to coat the blades 18, 20, to ensure proper functioning thereof in a subsequent use. Dispensing member 58 may be used to apply a medicinal agent to the skin if desired.

Although the illustrative embodiments of the present disclosure have been described herein with reference to the accompanying drawings, the above description, disclosure, and figures should not be construed as limiting, but merely as exemplifications of particular embodiments. It is to be understood, therefore, that the disclosure is not limited to those precise embodiments, and that various other changes and modifications may be effected therein by one skilled in the art without departing from the scope or spirit of the disclosure. For example, apparatus 10 may be used for any number of powered or non-powered trimmers, clippers, scissors or the like. It is further envisioned that apparatus 50 may be supplied with a hair trimmer or clipper to thereby form a kit for treating hair. Other arrangements are also envisioned.

What is claimed is:

1. An apparatus for maintaining a hair treatment device, which comprises:
a housing;
a brush assembly mounted to the housing, the brush assembly including a plurality of bristles dimensioned and adapted for at least one of cleaning and removal of hair from a clipper assembly of a hair treatment device; and
a dispensing member mounted to the housing, the dispensing member including a treatment agent for depositing on the clipper assembly.

2. The apparatus according to claim 1 wherein the dispensing member includes an absorbent member.

3. The apparatus according to claim 2 wherein the absorbent member includes one of a sponge, pad or cloth.

4. The apparatus according to claim 2 wherein the treatment agent is one of a lubricant, cleaning agent or medicinal.

5. The apparatus according to claim 1 including a cover releasably mounted to the housing to substantially enclose the dispensing member.

6. The apparatus according to claim 5 including an annular seal mounted to the housing to establish a substantial sealing relation with the cover upon mounting thereof to the housing.

7. The apparatus according to claim 5 including a hair clipper thereby forming a kit.
